(19) United States
(12) Patent Application Publication
(10) Pub. No.: US 2015/0323844 A1
(43) Pub. Date: Nov. 12, 2015

(54) LIQUID CRYSTAL DISPLAY PANEL AND METHOD FOR FABRICATING THE SAME

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Weixin MENG, Beijing (CN); Yongshan ZHOU, Beijing (CN)

(21) Appl. No.: 14/407,351

(22) PCT Filed: Jun. 23, 2014
(86) PCT No.: PCT/CN2014/080537

§ 371 Date: Dec. 11, 2014

(30) Foreign Application Priority Data
Jan. 2, 2014 (CN) 201410001022.X

(51) Int. Cl. G02F 1/1362; G02F 1/1337; G02F 1/1341; G02F 1/1335

(52) U.S. Cl. CPC G02F 1/136286; G02F 1/133512; G02F 1/133514; G02F 1/1337; G02F 1/1341

(57) ABSTRACT

A liquid crystal display panel and a method for fabricating the same are disclosed. The liquid crystal display panel includes a first substrate (1) and a second substrate (2) disposed as opposed to each other, and a liquid crystal layer disposed between the first substrate (1) and the second substrate (2). A plurality of protrusions (7) are disposed on a side of the first substrate (1) facing the liquid crystal layer and/or on a side of the second substrate (2) facing the liquid crystal layer. The protrusions (7) may reduce the diffusion speed of the liquid crystals (4) between the first substrate (1) and the second substrate (2), thereby alleviating contamination between the liquid crystals (4) and the seal glue, which further improves the product quality.

### FIELD OF THE ART

Embodiments of the present invention relate to a liquid crystal display panel and a method for fabricating the same.

### BACKGROUND

During the fabrication procedure of a Thin Film Transistor Liquid Crystal Display (TFT-LCD), assembly is necessary to form a cell. A convention cell-assembly process for LCDs comprises the following steps: first, seal glue is applied around a display region of a substrate; then drop injection is used to drop liquid crystals onto another substrate. After that, two glass substrates are attached to each other in the vacuum, that is, to perform the assembly process. Finally, the seal glue is cured and the assembly is finished.

### SUMMARY

The present disclosure provides a liquid crystal display panel and a method for fabricating the same.

In one aspect, the present invention provides a liquid crystal display panel, comprising: a first substrate and a second substrate disposed as opposed to each other, and a liquid crystal layer disposed between the first substrate and the second substrate; wherein a plurality of protrusions are disposed on a side of the first substrate facing the liquid crystal layer and/or on a side of the second substrate facing the liquid crystal layer.

As an example, the plurality of protrusions are formed on the side of the second substrate facing the liquid crystal layer.

As an example, the plurality of protrusions are made up of a plurality of buffer blocks formed on the side of the second substrate facing the liquid crystal layer.

As an example, the second substrate comprises a plurality of gate lines and a plurality of data lines, the buffer blocks comprises at least one of a gate line buffer block and a data line buffer block, the gate line buffer block corresponds to the gate line, the data line buffer block corresponds to the data line.

As an example, the gate line buffer block is disposed on the gate line and in contact with the gate line; the data line buffer block is disposed on the data line and in contact with the data line.

As an example, a width of the gate line buffer block is 1 to 1.1 times that of the gate line, and/or a width of the data line buffer block is 1 to 1.1 times that of the data line.

As an example, the buffer blocks are made of an insulating material.

As an example, the liquid crystal display panel further comprises: an alignment layer disposed on the second substrate, wherein the buffer blocks are disposed between the alignment layer and the second substrate.

As an example, the first substrate comprises a color film layer and a black matrix, the protrusion corresponds to the black matrix.

As an example, a height of the protrusion is less than 2/3 a distance between the first substrate and the second substrate.

Another aspect of the invention provides a method for fabricating a LCD panel. The method comprises the following steps: providing a first substrate and a second substrate; forming a plurality of protrusions on a side facing a liquid crystal layer of the first substrate and/or on a side of the second substrate facing the liquid crystal layer; injecting liquid crystals to the substrate having the plurality of protrusions formed thereon; and assembling the first substrate and the second substrate to form a cell such that the liquid crystal layer is formed between the first substrate and the second substrate and the protrusions extend towards the liquid crystal layer.

As an example, the step of forming the plurality of protrusions on a side of the first substrate facing the liquid crystal layer and/or on a side of the second substrate facing the liquid crystal layer comprises: forming a plurality of buffer blocks on the side of the second substrate facing the liquid crystal layer to form the plurality of protrusions.

As an example, the second substrate comprises a plurality of gate lines and a plurality of data lines, the buffer blocks comprise a gate line buffer block and a data line buffer block, the gate line buffer block corresponds to the gate line, the data line buffer block corresponds to the data line.

As an example, the step of forming the plurality of protrusions on a side of the first substrate facing the liquid crystal layer and/or on a side of the second substrate facing the liquid crystal layer comprises: forming the gate line buffer block above the gate line; and forming the data line buffer block above the data line.

As an example, the method further comprises: forming an alignment layer on the second substrate having the buffer blocks formed thereon.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a configuration of a known liquid crystal display panel;

FIG. 2 schematically illustrates a cross section taken along A-A of the liquid crystal display panel of FIG. 1;

FIG. 3 schematically illustrates a cross section of a liquid crystal display panel in accordance with an embodiment of the invention;

FIG. 4 schematically illustrates a configuration of a liquid crystal display panel in accordance with another embodiment of the invention; and

FIG. 5 schematically illustrates a cross section taken along C-C of the liquid crystal display panel of FIG. 4.

### DETAILED DESCRIPTION

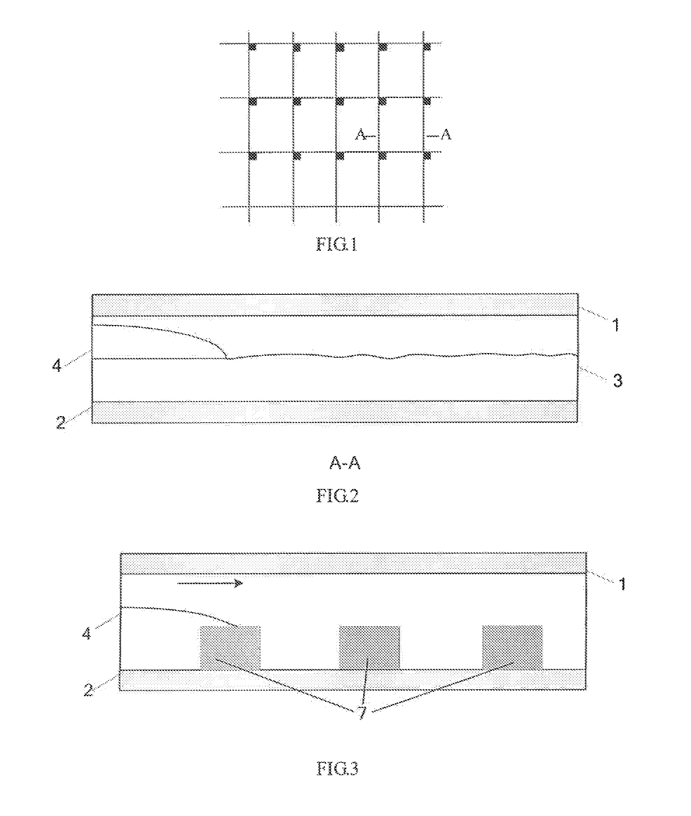

FIG. 1 schematically illustrates a configuration of a known liquid crystal display panel and its cross section taken along A-A is illustrated in FIG. 2. A liquid crystal layer is disposed between a first substrate 1 and a second substrate 2; an alignment layer 3 is coated on the second substrate 2 such that the liquid crystal layer maintains a certain orientation. As the surface of the alignment layer 3 is almost flat, the liquid crystal layer can diffuse freely on the alignment layer 3. As a result, the liquid crystal layer contacts the uncured seal glue before the seal glue is cured, which will cause the liquid crystal layer and the seal glue to diffuse to and contaminate each other and even allow the liquid crystal layer to penetrate through the seal glue.

A method of forming a stop wall inside the seal glue or between the liquid crystal and the seal glue was proposed. However, due to the tolerance of the fabrication process, it is inevitable that there might be non-seamless contact between the stop wall and an upper or lower substrate. When the liquid crystal diffuses to the stop wall, if there is a gap between the stop wall and the upper or lower substrate, the liquid crystal will contact the seal glue and cause contamination or even penetrate through the seal glue.

The present invention provides a liquid crystal display panel and a method for fabricating the same, which can effectively prevent the liquid crystals and the seal glue from contacting each other before the seal glue is cured.

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

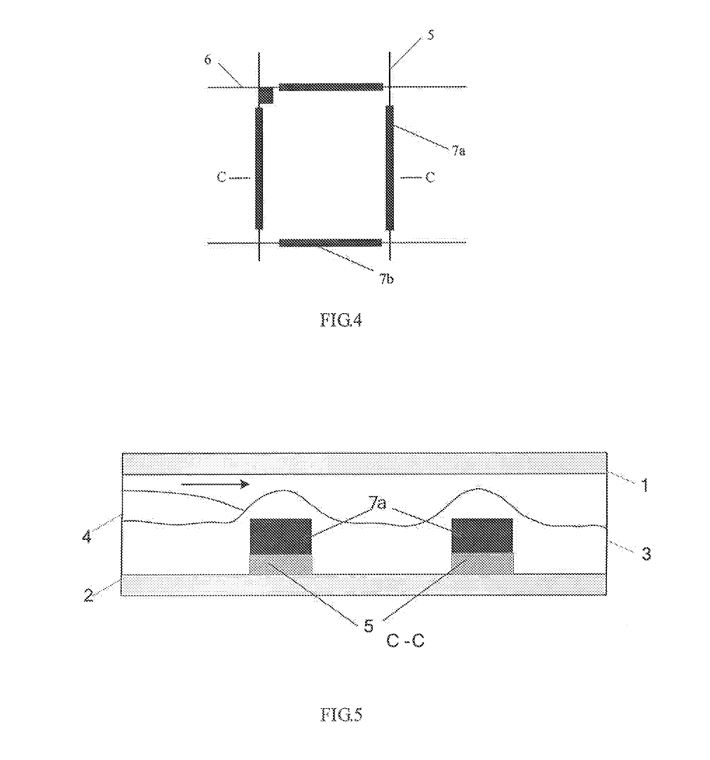

An embodiment of the invention provides a liquid crystal display panel. As illustrated in FIG. 3, the liquid crystal display panel comprises a first substrate 1 and a second substrate 2 disposed as opposed to each other and a liquid crystal layer disposed between the first substrate 1 and the second substrate 2. A plurality of protrusions 7 protruding to the liquid crystal layer are disposed on a side of the second substrate 2 facing the liquid crystal layer.

As the protrusions 7 protrude towards the liquid crystal layer, when liquid crystals 4 flow from the left to the right the flow speed of the liquid crystals 4 will be deceased by bumping into the protrusions 7. That is, the protrusions 7 can reduce the diffusion speed of the liquid crystal 4 between the first substrate 1 and the second substrate 2, which may reduce the contact between the liquid crystals 4 and the seal glue before the seal glue of the liquid crystal display panel is cured, thereby reducing the contamination between the liquid crystals 4 and the seal glue and preventing the liquid crystals 4 from penetrating through the seal glue, improving the product quality.

It can be appreciated that the direction indicated by the arrow of FIG. 3 is only one of diffusion directions of the liquid crystals 4. During a real fabrication process, the diffusion directions of the liquid crystals 4 may comprise other directions. When the first substrate 1 and the second substrate 2 are assembled to form a cell, the liquid crystals 4 are homogeneously spread between the first substrate 1 and the second substrate 2 to form the liquid crystal layer.

The protrusions 7 may be formed only on the side of the first substrate 1 facing the liquid crystal layer, or only on the side of the second substrate 2 facing the liquid crystal layer. Alternatively, the protrusions 7 may be formed on the side of the first substrate 1 facing the liquid crystal layer and on the side of the second substrate 2 facing the liquid crystal layer, as long as the protrusions can slow while not stopping the flow of the liquid crystals 4.

In the disclosure, specific methods for forming the protrusions will not be defined. As an example, after forming the alignment layer on the first and/or the second substrate, a plurality of the protrusions may be formed on a side of the alignment layer facing the liquid crystal layer. Alternatively, a plurality of buffer blocks may be disposed on a side of the first substrate facing the liquid crystal layer. The buffer blocks may be formed directly as the protrusions, or the buffer blocks form the protrusions together with the layer below the buffer blocks (such as the alignment layer, the insulation layer etc.). Similarly, a plurality of protrusions may be formed on a side of the second substrate facing the liquid crystal layer. The buffer blocks may be formed directly as the protrusions, or the buffer blocks form the protrusions together with the layer below the buffer blocks.

All of the plurality of the buffer blocks may be disposed on the side of the first substrate 1 facing the liquid crystal layer or on the side of the second substrate 2 facing the liquid crystal layer. Alternatively, a part of the plurality of the buffer blocks may be disposed on the side of the first substrate 1 facing the liquid crystal layer, while the other part of the plurality of the buffer blocks may be disposed on the side of the second substrate 2 facing the liquid crystal layer, as long as protrusions slowing the diffusion speed of the liquid crystals may be formed in the liquid crystal display panel.

To mitigate the influence on the aperture ratio of the liquid crystal display panel, as an example illustrated in FIG. 4, the buffer blocks comprise gate line buffer blocks 7b and data line buffer blocks 7a; the gate line buffer blocks 7b correspond to gate lines 6, the data line buffer blocks 7a correspond to data lines. It is to be noted that “corresponding to the gate lines 6” means projection locations of the gate line buffer blocks 7b on the second substrate 2 coincide with projection locations of the gate lines 6 on the second substrate 2, and “corresponding to the data lines 5” means projection locations of the data line buffer blocks 7a on the second substrate 2 coincide with projection locations of the data lines 5 on the second substrate 2. That is, the gate line buffer blocks 7b may be disposed above or below the gate lines 6, as long as the gate line buffer blocks 7b may form protrusions protruding towards the liquid crystal layer on locations corresponding to the gate lines. Similarly, the data line buffer blocks 7a may be formed above or below the data lines 5, as long the data line buffer blocks 7a may form protrusions protruding towards the liquid crystal layer on locations corresponding to the data lines. In FIG. 4, two gate lines 6 and two data lines 5 intersect each other to define a pixel region; the gate line buffer blocks 7b and the data line buffer blocks 7a are strips disposed around the pixel region. The liquid crystal display panel comprises a plurality of similar pixel regions.

To facilitate the arrangement of the buffer blocks, as an example, the gate line buffer blocks 7b are disposed above the gate lines and the data line buffer blocks 7a are disposed above the data lines. For example, the gate line buffer blocks 7b may be directly disposed on the gate lines 6 (that is, the gate line buffer blocks 7b contact the gate lines 6) or disposed as spaced apart from the gate lines 6 (that is, be located in a layer above the gate lines 6). Similarly, the data line buffer blocks 7a may be directly disposed on the data lines 5 (that is, the data line buffer blocks 7a contact the data lines 5) or disposed as spaced apart from the data lines 5 (that is, be located in a layer above the data lines 5). In FIG. 5, it only illustrates the scenario of the data line buffer blocks 7a being directly disposed on the data lines 5, the arrangement of the gate line buffer blocks 7b is similar to that of the data line buffer blocks 7a and not illustrated in the figure.

To allow the buffer blocks effectively reduce the diffusion speed of the liquid crystals 4 when the liquid crystals diffuse towards the buffer blocks, as an example illustrated in FIG. 5, a width of the data line buffer blocks 7a is 1 to 1.1 times that of the data line 5. Similarly, a width of the gate line buffer blocks 7b (not shown) is 1 to 1.1 times that of the gate line 6. By this means, the buffer blocks can reduce the diffusion speed of the liquid crystals 4 while not reduce the transmittance area of the pixels by too much.

In at least one embodiment, a length of the gate line buffer blocks 7b is less than or equal to a width of the pixel region, and a length of the data line buffer blocks 7a is less than or equal to a length of the pixel region. For example, as illustrated in FIG. 4, a length of the gate line buffer blocks 7b is less than the width of the pixel region (along the horizontal direction), a length of the data line buffer blocks 7a is less than the length of the pixel region (along the vertical direction). As a result, before the seal glue is cured, the buffer blocks may reduce the diffusion speed of the liquid crystals 4. Moreover, after the seal glue is cured, it may ensure that the liquid crystals completely fill a liquid crystal cell formed by the first substrate 1, the second substrate 2 and the glue seal.

In at least one embodiment, the liquid crystal display panel comprises a common electrode and a pixel electrode (not shown). For example, the common electrode and the pixel electrode are both disposed on the second substrate 2, with the pixel electrode disposed above the common electrode; the buffer blocks are disposed in a layer above the pixel electrode (such as a passivation layer).

As a electric field may be formed between the common electrode and the pixel electrode, to prevent the buffer blocks from affecting the electric field, in at least one embodiment, the buffer blocks are made of an insulating material. The insulating material may be an organic insulating material or an inorganic insulating material, such as silicon nitride and so on.

In at least one embodiment, as illustrated in FIG. 5, the liquid crystal display panel further comprises an alignment layer 3 disposed on the second substrate 2. The alignment layer 3 is oriented by UV-irradiating or rubbing, such that liquid crystals in contact with the alignment layer 3 can maintain a certain orientation. The data line buffer blocks 7a are disposed between the alignment layer 3 and the second substrate 2. Due to the existence of the data line buffer blocks 7a, a part of the alignment layer 3 corresponding to the data line buffer blocks 7a protrudes upwards, thereby forming the protrusions, so as to reduce the diffusion speed of the liquid crystals 4.

In at least one embodiment, the first substrate 1 comprises a color filter layer and a black matrix disposed thereon, and color filter films of corresponding colors are disposed in each of the pixel regions. The plurality of protrusions formed on the first substrate 1 and/or the second substrate 2 correspond to the black matrix, that is, being located in the black matrix region, such that the black matrix may block the protrusions, thereby mitigate the influence on the aperture ratio of the liquid crystal display panel by the protrusions.

In at least one embodiment, to prevent the protrusions from affecting the uniformity of the height of the liquid crystal cell, a height of the protrusions is 2/3 a thickness of the cell gap, that is, the height of the protrusions is less than or equal to 2/3 a distance between the first substrate 1 and the second substrate 2. However, a height of the protrusions should not be too little, that is, the height of the protrusions is configured in such a way that allows the protrusions to reduce the diffusion speed. In real applications, the height of the protrusions may be determined according to a dimension of the liquid crystal display panel. For example, when the liquid crystal display panel to be cell-assembled is of a large size, a distance between the liquid crystals 4 and the seal glue is large; therefore, the protrusions may be of a small height. When the liquid crystal display panel to be cell-assembled is of a small size, a distance between the liquid crystals 4 and the seal glue is small; therefore, the protrusions may be of a large height, as long as the protrusions may reduce the diffusion speed of the liquid crystals 4 while not affecting the thickness of the cell gap of the liquid crystal cell.

As illustrated in FIG. 5, before forming the alignment layer 3 on the second substrate 2, the data line buffer blocks 7a are formed on the data line 5. Simultaneously, the gate line buffer blocks 7b are formed on the gate line 6, such that protrusions are formed on locations of the alignment layer 3 which corresponds to the data line buffer blocks 7a and the gate line buffer blocks 7b. When liquid crystals 4 are injected to the second substrate 2, the diffusion speed of the liquid crystals 4 is reduced by the blocking effect of the protrusions when the liquid crystals 4 diffuse along the alignment layer 3, thereby reducing the contamination between the liquid crystals and the seal glue caused by the contact there-between and preventing the liquid crystals from crossing the seal glue, thereby improving the product quality.

According to another embodiment of the invention, a method for fabricating a liquid crystal display panel is provided. The method comprises steps of:

S1: providing a first substrate and a second substrate;

S2: forming a plurality of protrusions on a side of the first substrate facing a liquid crystal layer and/or on a side of the second substrate facing the liquid crystal layer;

S3: injecting liquid crystals to the substrate having the plurality of protrusions formed thereon; and

S4: cell-assembling the first substrate and the second substrate such that the liquid crystal layer is formed between the first substrate and the second substrate and the protrusions extend towards the liquid crystal layer.

In at least one embodiment, the step S2 comprises forming a plurality of buffer blocks on the side of the second substrate facing the liquid crystal layer.

For example, a plurality of buffer blocks are formed through a patterning process on the side of the second substrate facing the liquid crystal layer. As an example, the buffer blocks are formed through a patterning process such as printing and transferring. For example, a layer of buffer block material is first deposited (such as via coating, sputtering or evaporation) on the side of the second substrate facing the liquid crystal layer. Then photoresist is applied and a mask is disposed above the photoresist to allow irradiated photoresist to get exposed. After that the unexposed photoresist is removed by development, followed by removing the film not covered by the photoresist by etching (or depositing film material having the photoresist retained on the photoresist). Finally, the remaining photoresist is peeled off to obtain a plurality of buffer blocks.

In at least one embodiment, the second substrate comprises a plurality of gate lines and a plurality of data lines, the buffer blocks comprise gate line buffer blocks and/or data line buffer blocks, the gate line buffer blocks correspond to the gate lines, the data line buffer blocks correspond to the data lines.

When the buffer blocks comprise both gate line buffer blocks and data line buffer blocks, the step S1 comprises:

forming the gate line buffer blocks above the gate lines;

forming the data line buffer blocks above the data lines.

In at least one embodiment, the method further comprises, after the above step S2, forming an alignment layer on the second substrate having the buffer blocks formed thereon.

An example of a method for fabricating a liquid crystal display panel will be described in the following. The method comprises steps of:

forming elements such as gate lines, data lines, TFTs, pixel electrodes and common electrodes on a second base substrate to form a second substrate;

forming gate line buffer blocks above the gate lines and forming data line buffer blocks above the data lines by using the above-mentioned patterning process;

forming an alignment layer on the second substrate to overlay the gate line buffer blocks and the data line buffer blocks;

injecting liquid crystals to a first substrate which comprises a color filter layer and black matrix;

applying a seal glue around a display region of the first substrate;

assembling the first substrate and the second substrate in vacuum to form a cell;

curing the seal glue by UV-irradiation or high-temperature oven heating.

In the above fabrication method, protrusions protruding towards the liquid crystal layer are disposed on a side of the first substrate facing the liquid crystal layer and/or on a side of the second substrate facing the liquid crystal layer. The protrusions may reduce the diffusion speed of the liquid crystals between the first and second substrates, thereby decreasing the contact between the liquid crystals and the seal glue before the seal glue is cured, reducing contamination between the liquid crystals and the seal glue and preventing the liquid crystals from penetrating through the seal glue, so as to improve the product quality.

In an embodiment of the invention, the first substrate is a color filter substrate, the second substrate is an array substrate. However, it can be understood by those skilled in the art that the first substrate and the second substrate are interchangeable. Moreover, at least one of the gate line buffer block and data line buffer block exist. For example, the gate line buffer blocks are formed only on the first or the second substrate; alternatively, only data line buffer blocks are formed, which can still achieve the object of reducing the diffusion speed of the liquid crystals.

What are described above is related to the illustrative embodiments of the disclosure only and not limitative to the scope of the disclosure; the scopes of the disclosure are defined by the accompanying claims.

The present invention is based on and claims priority from Chinese Application No. 201410001022.X filed on Jan. 2, 2014, the whole disclosure of which is incorporated herein by reference.

What is claimed is:

1. A liquid crystal display panel, comprising:
a first substrate and a second substrate disposed as opposed to each other, and
a liquid crystal layer disposed between the first substrate and the second substrate;
wherein a plurality of protrusions are disposed on a side of at least one of the first substrate and the second substrate facing the liquid crystal layer.

2. The liquid crystal display panel of claim 1, wherein the plurality of protrusions are formed on the side of the second substrate facing the liquid crystal layer.

3. The liquid crystal display panel of claim 2, wherein the plurality of protrusions are made up of a plurality of buffer blocks formed on the side of the second substrate facing the liquid crystal layer.

4. The liquid crystal display panel of claim 3, wherein the second substrate comprises a plurality of gate lines and a plurality of data lines, the buffer blocks comprise at least one of a gate line buffer block and a data line buffer block, the gate line buffer block corresponds to the gate line, the data line buffer block corresponds to the data line.

5. The liquid crystal display panel of claim 4, wherein the gate line buffer block is disposed on the gate line and in contact with the gate line; the data line buffer block is disposed on the data line and in contact with the data line.

6. The liquid crystal display panel of claim 5, wherein a width of the gate line buffer block is 1 to 1.1 times that of the gate line, and/or a width of the data line buffer block is 1 to 1.1 times that of the data line.

7. The liquid crystal display panel of any one of claims 3 to 6, wherein the buffer blocks are made of an insulating material.

8. The liquid crystal display panel of any one of claims 3 to 6, further comprising: an alignment layer disposed on the second substrate, wherein the buffer blocks are disposed between the alignment layer and the second substrate.

9. The liquid crystal display panel of any one of claims 1 to 8, wherein the first substrate comprises a color filter layer and a black matrix, the protrusions correspond to the black matrix.

10. The liquid crystal display panel of any one of claims 1 to 9, wherein a height of the protrusion is less than 2/3 a distance between the first substrate and the second substrate.

11. A method for fabricating a liquid crystal display panel, comprising the following steps:
providing a first substrate and a second substrate;
forming a plurality of protrusions on a side of at least one of the first substrate and the second substrate facing the liquid crystal layer;
injecting liquid crystals to the substrate having the plurality of protrusions formed thereon; and
assembling the first substrate and the second substrate to form a cell such that the liquid crystal layer is formed between the first substrate and the second substrate and the protrusions extend towards the liquid crystal layer.

12. The method of claim 11, wherein the step of forming the plurality of protrusions on a side of at least one of the first substrate and the second substrate facing the liquid crystal layer comprises:
forming a plurality of buffer blocks on the side of the second substrate facing the liquid crystal layer to form the plurality of protrusions.

13. The method of claim 12, wherein the second substrate comprises a plurality of gate lines and a plurality of data lines, the buffer blocks comprise a gate line buffer block and a data line buffer block, the gate line buffer block corresponds to the gate line, the data line buffer block corresponds to the data line.

14. The method of claim 13, wherein the step of forming the plurality of protrusions on a side of at least one of the first substrate and the second substrate facing the liquid crystal layer. comprises:
forming the gate line buffer block above the gate line; and
forming the data line buffer block above the data line.

15. The method of any one of claims 12 to 14, further comprising: forming an alignment layer on the second substrate having the buffer blocks formed thereon.
